(19) United States
(12) Patent Application Publication
(10) Pub. No.: US 2006/0070745 A1
(43) Pub. Date: Apr. 6, 2006

(54) Modular release mechanism for fire protection sprinklers

(75) Inventor: George S. Polan, Perkiomenville, PA (US)

Correspondence Address: FITZPATRICK CELLA HARPER & SCINTO, 30 ROCKEFELLER PLAZA, NEW YORK, NY, 10112, US

(73) Assignee: THE RELIABLE AUTOMATIC SPRINKLER CO., INC., Mount Vernon, NY (US)

(21) Appl. No.: 10/959,892

(22) Filed: Oct. 6, 2004

(51) Int. Cl. A62C 35/00; A62C 37/36; A62C 37/08

(52) U.S. Cl. 169/19; 169/5; 169/37

(57) ABSTRACT

A release mechanism is provided for a fire protection sprinkler having a body, including an output orifice sealed with a seal cap. The body has two arms extending therefrom that meet at a hub having a preload mechanism. The release mechanism includes a lever having a first end mounted on the preload mechanism. The mechanism further includes a strut having a first end mounted on the seal cap and a second end mounted on the first end of the lever. A thermally-responsive element is mounted in a second end of the lever, opposite the first end, and the thermally-responsive element has a displaceable member extending therefrom, so as to contact the strut.

### BACKGROUND OF THE INVENTION

1. Field of the Invention

The present invention relates generally to a release mechanism for a fire protection sprinkler. More specifically, the present invention relates to a release mechanism having a thermally-responsive element arranged between a lever and a strut, forming a modular assembly for installation into a sprinkler head.

2. Related Art

Fire protection sprinklers conventionally are connected to a conduit of pressurized fire-extinguishing fluid, such as water. A typical sprinkler has a base with a threaded portion for connection to the conduit to receive the fluid and an output orifice to output the fluid to provide fire control and/or suppression. The output orifice is sealed by a seal cap, which is held in place by a release mechanism. The release mechanism is designed to release the cap under predetermined conditions, thereby initiating the flow of fire-extinguishing fluid. A typical release mechanism includes a latching mechanism and a thermally-responsive element, e.g., a frangible bulb.

Certain conventional sprinklers have a pair of arms that extend from the base portion and meet at a hub portion to form a frame. The hub portion is spaced apart from the output orifice of the base portion and is aligned with a longitudinal axis thereof. The hub portion may have a set-screw configured to apply a pre-tension force to the latching mechanism. A deflector plate may be mounted on the hub, transverse to the output orifice, to provide dispersion of the output fluid in the transverse direction.

U.S. Pat. No. 3,625,289 is an example of a release mechanism for a fire protection sprinkler. The release mechanism includes a lever, with a lower end pivotally mounted on a set-screw at the hub end of the sprinkler. The lever has a series of bends which cause the lever to extend through an opening in a rectangular, flat strut. The strut extends from the seal cap to an offset position on the lower end of the lever. A retaining assembly, having a cylindrical member with a ball, a disk, and a fusible alloy, is mounted transversely across the strut opening, so as to oppose the rotation of the lever by preventing the end portion of the lever from passing through the opening. In another embodiment, the lever is pivotally mounted on the seal cap, and the strut is mounted between the center of the set-screw and an offset position on the seal cap end of the lever.

U.S. Pat. No. 4,376,465 shows a release mechanism with a lever having a lower flange portion, an upper flange portion, and two arms extending from the sides. The lower flange portion has a dimple for mounting on the set-screw at the hub-end of the sprinkler body. A bowed strut is positioned between the lower flange portion of the lever, offset from the set-screw, and the seal cap to hold the cap in place. A tubular assembly, including two balls and a fusible element, is mounted between the side arms of the lever, transverse to the lever. The tubular assembly is forced against the strut by the lever. In another embodiment, the lower flange portion of the lever is pivotally mounted on the seal cap, and the strut is mounted between a center of the set-screw and an offset position on the lower flange portion of the lever.

U.S. Pat. No. 4,440,234 shows a release mechanism having a strut, a lever, and a retainer. One end of the strut engages the seal cap, and the other end of the strut is engaged by a lever, which is in turn mounted on a set-screw. The end of the strut that engages the lever is offset from the set-screw, so as to impart a rotational force to the lever. The strut includes arms that hold the retainer in position, spaced apart from and transverse to the strut. The retainer is a tubular member having a eutectic material, a disk, and a ball, which protrudes from the retainer. An upper end of the lever, opposite the set-screw end, is held in position by the retainer.

U.S. Pat. No. 4,732,216 shows a release mechanism having latch assembly that includes a U-shaped ejection plate, the closed end of which is inserted into a slot in the seal cap. The tips of the open end of the U-shaped ejection plate are mounted in a channel of an end collar, which in turn is pivotally mounted on a set-screw. The latch assembly further includes a thermally-responsive element having a tubular housing that contains a fusible pellet, a slug, and a ball, which protrudes from the housing. The lower end of the thermally-responsive element is mounted in the end collar with an offset. The upper end of the thermally-responsive element, i.e., the end from which the ball protrudes, is lodged against the U-shaped ejection plate.

Many conventional release mechanisms are formed of numerous separate parts that must be installed by hand into a sprinkler head, which leads to higher manufacturing costs. In addition, some conventional designs subject the thermally-responsive element to large system loads, because they bear a significant portion of the compressive force between the seal cap and the set-screw. Applying large system loads to the thermally-responsive element increases the structural requirements for these elements, e.g., requires a thicker structure, thereby resulting in less thermal sensitivity and slower response time.

### SUMMARY OF THE INVENTION

In one aspect, the present invention provides a release mechanism for a fire protection sprinkler. The sprinkler has a body, including an output orifice sealed with a seal cap, and two arms extending from the body that meet at a hub that has a preload mechanism. The release mechanism includes a lever having a first end mounted on the preload mechanism. The release mechanism further includes a strut having a first end mounted on the seal cap and a second end mounted on the first end of the lever. The release mechanism further includes a thermally-responsive element mounted on a second end of the lever, opposite the first end. The thermally-responsive element has a displaceable member extending therefrom so as to contact the strut.

Embodiments of the present invention may include one or more of the following features. The release mechanism may be formed as a modular assembly, such that it is installable into a sprinkler head as a single unit. The first end and the second end of the lever may be substantially planar portions formed at approximately right angles to a substantially planar central portion of the lever. The thermally-responsive element may be mounted in the second end of the lever by inserting a closed end of the thermally-responsive element, opposite an open end from which the displaceable member extends, into an opening in the second end of the lever. The release mechanism may include a first insulator surrounding a portion of the displaceable member and a portion of the open end of the thermally-responsive element. At least a portion of the first insulator may be configured to be inserted into the opening in the second end of the lever so as to isolate the sensor from the lever.

The strut may include a substantially planar central portion and substantially planar side flanges formed at approximately right angles to the central portion. The strut also may include a window in a central portion of a main surface thereof, and the displaceable member may contact the strut at an inner edge of the window. The thermally-responsive element may be positioned within the strut window. The inner edge of the strut window may have a notch formed therein, and the displaceable member may rest in the notch.

The thermally-responsive element may include a sensor having an opening and a hollow interior portion and a fusible material provided in the interior portion. The displaceable member may be inserted in the sensor so as to contact the fusible material and extend from the opening.

These and other objects, features and advantages will be apparent from the following description of the preferred embodiments of the present invention.

### BRIEF DESCRIPTION OF THE DRAWINGS

The present invention will be more readily understood from a detailed description of the preferred embodiments taken in conjunction with the following figures.

FIG. 1 is an isometric view of a modular release mechanism according to the present invention installed in a fire protection sprinkler.

FIG. 2 is an exploded view of the major components of the modular release mechanism.

FIG. 3 is a sectional view of a lever.

FIG. 4 is an isometric view of the lever.

FIG. 5 is a plan view of a flat blank used to form the lever.

FIG. 6 is a front plan view of a strut.

FIG. 7 is a plan view of the strut.

FIG. 8 is a side sectional view of the strut.

FIG. 9 is a plan view of a flat blank used to form the strut.

FIG. 10 is an isometric view of a sensor.

FIG. 11 is a sectional view of the sensor assembly, including fusible material, a plunger, and upper and lower insulators.

FIG. 12 is a isometric view of the lower insulator.

FIG. 13 is an isometric view of the upper insulator.

FIG. 14 is a side sectional view of the modular release mechanism positioned between the set-screw and the seal cap.

FIG. 15 is an isometric view of the modular release mechanism as seen from the lever side.

FIG. 16 is an isometric view of the modular release mechanism as seen from the strut side.

FIG. 17 is a sectional view of an alternative embodiment of the sensor assembly, including fusible material, a plunger, a spherical ball, and upper and lower insulators.

FIG. 18 is an isometric view of the alternative embodiment of the lower insulator.

FIG. 19 is a side sectional view of the alternative embodiment of the modular release mechanism.

### DETAILED DESCRIPTION OF THE PREFERRED EMBODIMENTS

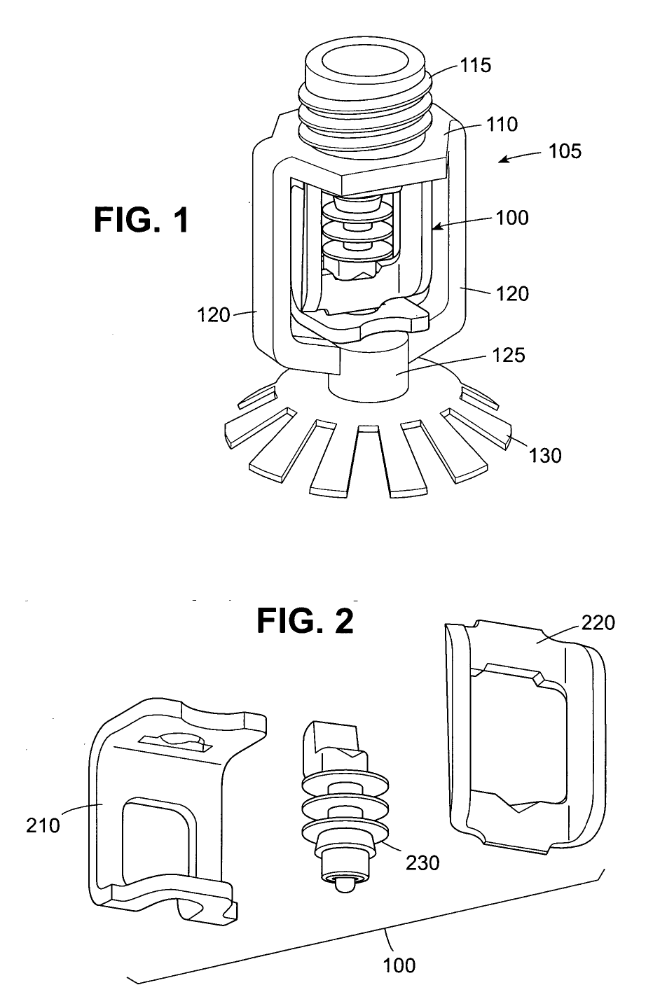

As shown in FIG. 1, a modular release mechanism 100 in accordance with the present invention may be installed in a fire protection sprinkler 105 having a base 110 with a threaded portion 115 for connection to a conduit (not shown) providing pressurized fire protection fluid, such as water. The sprinkler 105 has two arms 120 extending from the base 110 and meeting at a hub 125, which has a deflector plate 130 mounted thereon. The sprinkler 105 shown in the example of FIG. 1 is a pendant sprinkler, designed to depend downward from a conduit running along a ceiling, but the modular release mechanism 100 also may be used in other sprinkler configurations, such as upright and sidewall sprinklers.

One end of the release mechanism 100 is mounted in a slot in a seal cap 1410 (see FIG. 14), sealing an output orifice of the base 110. The other end of the release mechanism 100 is mounted on a preload mechanism, e.g., a set-screw 1420 (see FIG. 14), in the hub 125, which allows for the application and adjustment of the compressive preload force (or “pre-tension force”) necessary to keep the components of the sprinkler 105 in place in the absence of a system load, i.e., the load applied by the pressure of the fluid on the seal cap 1410 under normal installation conditions.

FIG. 2 shows the major components of the modular release mechanism 100: a lever 210, a strut 220, and a thermally-responsive element 230. These components, which are each discussed in further detail below, may be assembled to form a modular unit for installation in a sprinkler head. One of the advantages resulting from the modular nature of the present invention is that it is amenable to installation using an automated process, for example, using a robotic arm or other mechanized assembly techniques. Use of such processes may significantly reduce manufacturing costs. Another advantage is that the lever 210 and strut 220 form a protective housing around the thermally-responsive element 230, thereby protecting the thermally-responsive element 230 from physical damage, e.g., from handling and installation.

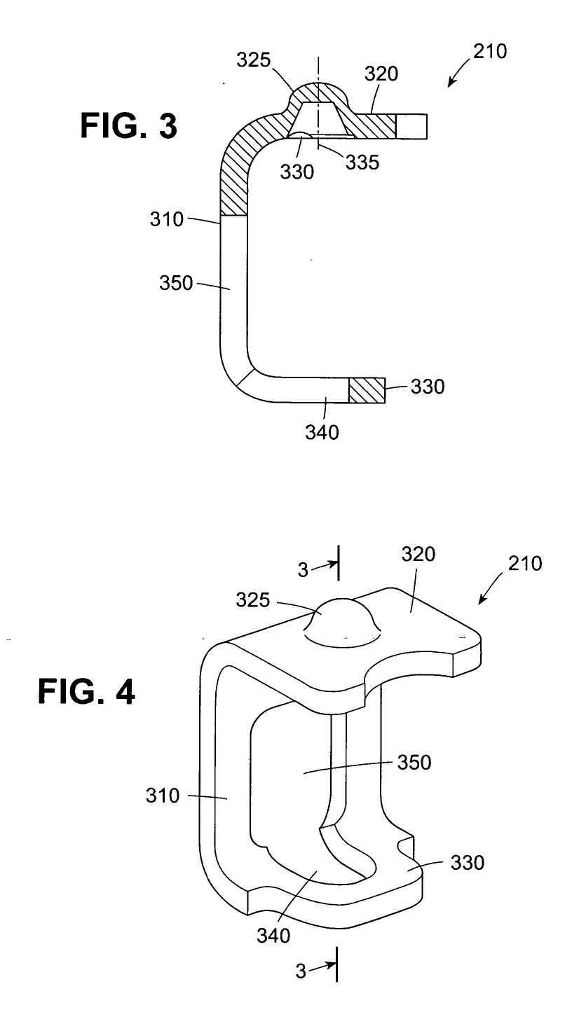

The lever 210, as shown in FIGS. 3 and 4, is for example a rectangular, thin member having a planar central portion 310 and two planar end portions 320 and 330 at approximately right-angles to the central portion 310. One end 320 of the lever has a spherical protrusion 325 for insertion into a corresponding dimple in the end of the set-screw in the hub 125 of the sprinkler 105 (see FIG. 14). The tip of this protrusion forms a fulcrum about which rotational forces act on the lever 210. A slot is provided on the inner surface of this end of the lever, on a side opposite the protrusion, to receive an end of the strut. The slot 330 is offset from the center line 335 of the protrusion 325, such that the force applied by the strut 220 tends to rotate the lever 210 about the protrusion 325. At the opposite end 330 of the lever, a U-shaped opening 340 is provided to receive an end of the thermally-responsive element 230. The slot-like shape of the opening 340 prevents movement of the thermally-responsive element 230 in certain directions, but allows for easy installation. An opening 350 also is provided in the central portion 310 of the lever 210 to allow air flow to reach the thermally-sensitive element 230 (the opening may form a single continuous opening with the U-shaped opening 340, as shown in this example).

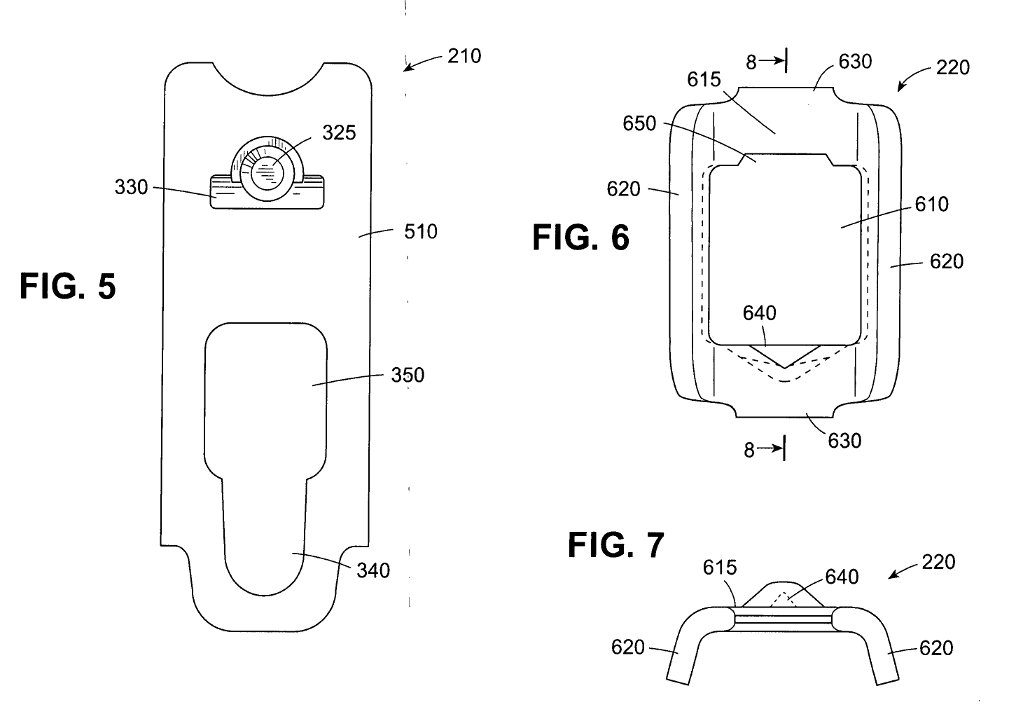

As shown in FIG. 5, the lever 210 may be stamped and formed on a progressive die. The protrusion 325, slot 330, and openings 340 and 350 are formed in a flat blank 510 during the stamping process, and then the ends of the blank 510 are bent to form the end portions of the lever 210. The blank 510 is formed of metal, e.g., brass, and may for example be about 0.05 inches thick.

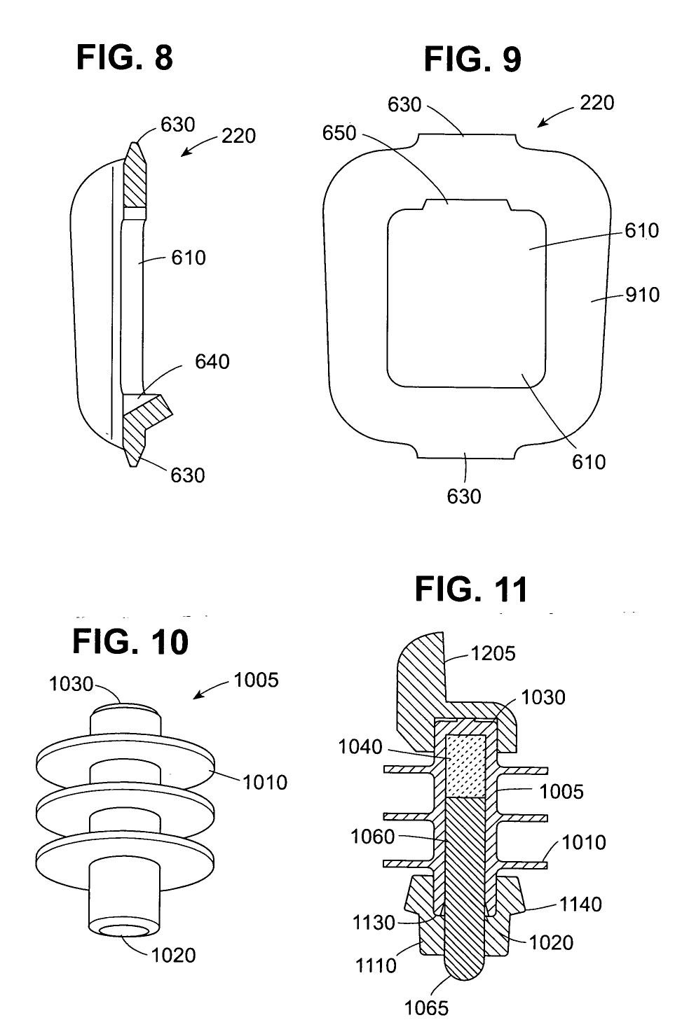

The strut 220, as shown in FIGS. 6-8, is a generally rectangular, planar member, with a generally rectangular window 610 (which for example may be rectangular or trapezoidal) formed in a central portion 615. The window 610 helps allow air flow to reach the thermally-responsive element 230. Side flange portions 620 extend from the sides of the strut 220 approximately perpendicularly. In the example shown, the side flange portions 620 extend at an angle of about 75° with respect to the plane of the central portion 615. These side flanges 620 help maintain the rigidity of the strut 220 by opposing bending forces, thereby allowing thinner, lighter materials to be used. This in turn results in lighter weight and cost for the overall modular release mechanism assembly 100. The side flanges 620 also act as air foils to channel air directly onto the thermally-responsive element 230, which helps to improve responsiveness, and help protect the thermally-responsive element 230 from physical impact, e.g., due to handling, installation or thrown objects. Tapered edge portions 630 are provided along the top and bottom edges to allow insertion of the strut 220 into the slot in the seal cap 1410 (see FIG. 14) and the slot 330 in the end portion 320 of the lever 210.

A notch 640 is provided at the bottom of the window 610 for receiving an end portion of the thermally-responsive element 230. The notch 640 is formed by bending the edge of the window 610 outward, e.g., at an angle of about 60°, to form a V-shaped protrusion (which may be formed by a stamping process). As discussed in further detail below, an end of the thermally-responsive element 230 is forced against the center of the notch 640 by the pre-tension and system forces. The shape of the notch 640 tends to keep the thermally-responsive element 230 stabilized in the center of the window 610. In addition, a rectangular cutout portion 650 may be formed on an inner edge of the window 610, opposite the notch 640. This cutout 650, as described in further detail below, receives an insulator attached to the thermally-responsive element 230 and also tends to keep the thermally-responsive element 230 stabilized in the center of the window 610.

As shown in FIG. 9, the strut 220 may be formed from a flat blank 910 resulting from a stamping process. The overall shape of the strut 220 and the rectangular window 610 are formed during the stamping process, and then the sides of the blank 910 are bent to form the side flange portions 620 of the strut 220. The blank 910 is formed of metal, e.g., brass, and may for example be about 0.05 inches thick. The side flanges 620 may be wider at a top portion of the strut, as is apparent from the trapezoidal shape of the flat blank 910.

The thermally-responsive element 230 includes a sensor 1005, which, as shown in FIG. 10, is a generally cylindrical housing with circumferential fins 1010 on an outer surface thereof. The fins 1010 improve the thermal conductivity, and therefore the responsiveness of the sensor 1005 to heated air flow. Other configurations for the sensor 1005 are possible. For example, the sensor may be formed by a cylindrical housing without fins.

As shown in FIG. 11, the sensor 1005 has a cylindrical interior with an open end 1020 and a closed end 1030. A fusible material 1040 designed to liquefy at a predetermined temperature, such as for example a fusible alloy pellet, is provided in the closed end 1030 of the sensor 1005. A displaceable member 1060 is installed in the sensor 1005 so as to contact the fusible material 1040 and extend from the open end 1020 of the sensor 1005.

For example, a solid, cylindrical plunger may be used, which has a flat end that rests on the fusible material 1040 and a rounded end 1065 that extends from the open end 1020 of the sensor 1005. In the assembled modular release mechanism 100, the rounded end 1065 of the plunger rests in the notch 640 provided in the window 610 of the strut 220 (see FIG. 6). Upon liquefaction of the fusible material 1040, the force applied by the displaceable member 1060 to the fusible material 1040 (due to the force on the displaceable member 1060 applied by the strut 220) causes the fusible material 1040 to flow out of the sensor 1005, thereby allowing the displaceable member 1060 to move further into the sensor 1005.

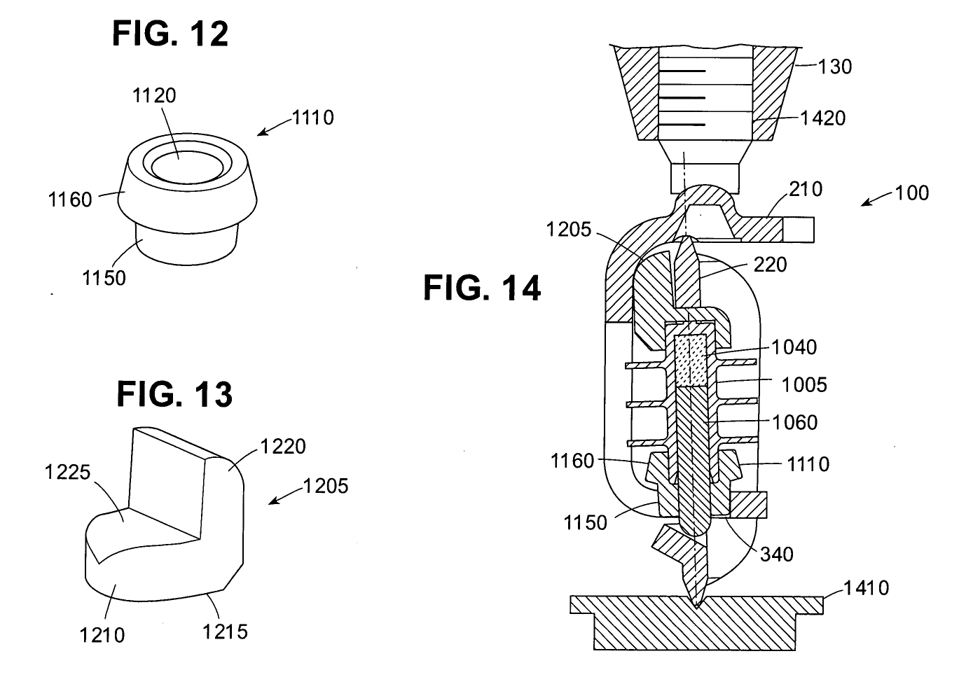

A lower insulator 1110 formed of insulative material, e.g., ceramic, is provided around the open end 1020 of the sensor 1005. The lower insulator 1110, as shown in FIG. 12, is generally cylindrical with an opening 1120 through the center for insertion over the end of the sensor 1005 and displaceable member 1060. The inner radius of the opening 1120 in the lower insulator 1110 has a step 1130 at about the midpoint of its length to accommodate the differing radii of the sensor 1005 and displaceable member 1060 (see FIG. 11). The lower insulator 1110 maintains a slip fit, so as to allow the displaceable member 1060 to move freely into the sensor 1005 upon liquefaction of the fusible material 1040. The outer radius of the lower insulator 1110 also includes a step 1140, so as to allow the sensor 1005 to be installed and to maintain the proper position in the U-shaped opening 340 at the end 330 of the lever 210, as shown in FIG. 14. As shown, the smaller outer radius portion 1150 of the lower insulator 1110 fits into the U-shaped opening 340 of the lever 210, while the larger outer radius portion 1160 rests on top of the U-shaped opening 340.

The lower insulator 1110 serves several functions. For example, as discussed above, it helps maintain the proper position of the sensor 1005 with respect to the lever 210. In addition, the lower insulator 1110 helps distribute the force applied by the end 330 of the lever 210 (due to the rotational force on the lever) to both the displaceable member 1060 and the sensor 1005. This is the case, because the smaller outer radius portion 1150 of the lower insulator 1110 surrounds the displaceable member 1060, and the larger outer radius portion 1160 of the lower insulator 1110 surrounds the sensor 1005. Thus, the lower insulator 1110 helps prevent a differential torque on the displaceable member 1060 with respect to the sensor 1005, which could cause it to jam upon activation.

The lower insulator 1110 also ensures that the sensor 1005 is insulated from other parts of the sprinkler body that can act as a cold sink and prevent proper release of the release mechanism. More specifically, the sprinkler body is formed of thermally conductive metal and is connected to a conduit, which is also thermally conductive. These structures tend to act as a cold sink by conducting heat away from the sensor 1005. The heat arising from a fire condition could be absorbed by these structures and wicked away from the sensor 1005, thereby preventing the melting of the fusible material 1040 and the proper release of the release mechanism 100.

An upper insulator 1205, as shown in FIGS. 11 and 13, is provided on the closed end 1030 of the sensor 1005. The upper insulator 1205 is also formed of insulative material, e.g., ceramic, and helps prevent the sensor 1005 from contacting portions of the sprinkler body than might act as a cold sink. The upper insulator 1205 has a cylindrical portion 1210 with a cylindrical opening 1215 (see FIG. 13) that allows it to be installed onto the end of the sensor 1005. The upper portion 1220 of the upper insulator 1205 has a shelf portion 1225, which allows the upper insulator 1205 to fit within a cutout 650 on an inner edge of the window 610 of the strut 220 (see FIGS. 6 and 9). The upper portion 1220 also fits between the sensor 1005 and the lever 210 to maintain the proper positioning of these components, even in the absence of pre-tension forces. In other words, the upper insulator 1205 prevents the lever 210 from rotating away from the strut 220 in the direction opposite to the release rotation direction (i.e., prevents a counterclockwise rotation of the lever 210, as depicted in FIG. 14).

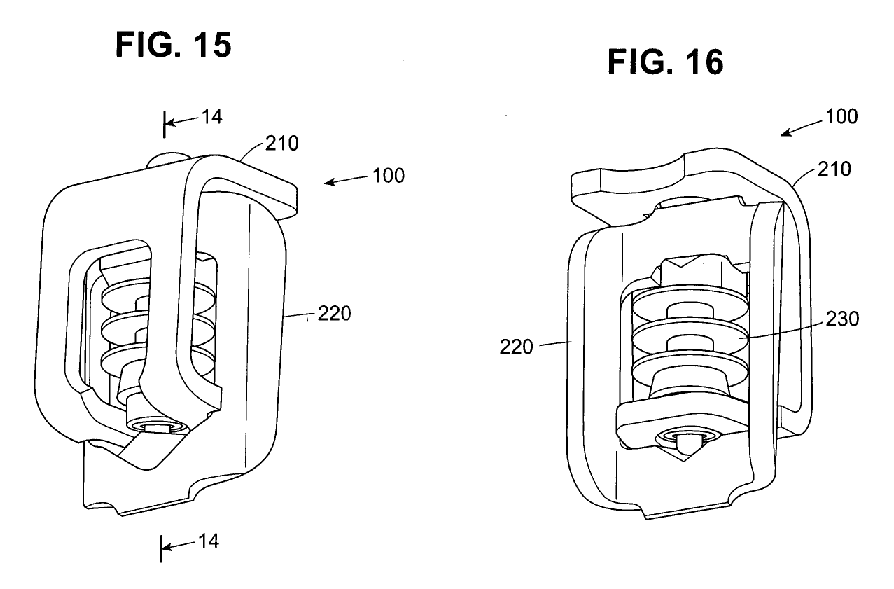

FIG. 14 shows a sectional view of the modular release mechanism 100, including the lever 210, strut 220, sensor 1005, fusible material 1040, displaceable member 1060, lower insulator 1110, and upper insulator 1205, arranged as discussed above. This configuration makes it possible to assemble a single modular release component, as shown in FIGS. 15 and 16, prior to installation in a sprinkler head. This in turn can allow for automated assembly of the sprinkler head, resulting in lower manufacturing costs. By contrast, some devices require the pretension force provided by the set-screw of the sprinkler head to maintain the assembled relationship of the release mechanism components. In such cases, the release mechanism components cannot be handled as a modular assembly and instead must be individually hand-installed into a sprinkler head.

As discussed above, the modular release mechanism 100 is designed to be installed in a sprinkler head 105 (see, e.g., FIG. 1) that is connected to a pressurized fluid conduit. Under such circumstances, the modular release mechanism 100 is subjected to a pre-tension load force applied by the set-screw 1420 and a system load force applied by the pressure of the fluid on the seal cap 1410. These forces are primarily transmitted to the strut 220, which is positioned almost directly in line with these two forces. This is advantageous in that the sensor 1005 may be made thinner, lighter, and more responsive, i.e., able to transmit heat more readily to the fusible material 1040. To help handle these forces, as noted above, the strut 220 has side flanges 620 for increased strength.

The end of the strut 220 nearest the set-screw 1420 is positioned slightly offset from the pivot point or center of rotation of the lever (the interface between the lever protrusion 325 and the end of the set-screw 1420 may be a sector of an arc, rather than a point, in which case the center of rotation of the lever 210 may be located at a point within the interior of the protrusion 325). In the embodiment shown in FIG. 14, the strut 220 is offset by an angle of about 3.1° with respect to a line between the lever 210 pivot point and the center of the seal cap 1410. This offset produces a moment on the lever 210 about the pivot point, which is balanced by the force of the end of the displaceable member 1060 against the strut notch 640. However, due to a substantial difference in the respective moment arms, the force of the displaceable member 1060 against the strut notch 640 is significantly less than the compressive forces, i.e., the pre-tension and system loads, applied to the strut 220.

The modular release mechanism 100 is designed to release at a predetermined temperature, thereby activating the sprinkler. At that temperature, the fusible material 1040 in the sensor 1005 melts, allowing the displaceable member 1060 to move further into the interior of the sensor 1005 (the displaceable member 1060 being subject to a force applied by the strut notch 640 that is in part longitudinally aligned with the sensor 1005). The displaceable member 1060 becomes disengaged with the strut notch 640, at which point the lever 210 is no longer constrained from rotation. The rotation of the lever 210 (in a clockwise direction, as depicted in FIG. 14) causes the release of the strut 220 and thermally-responsive element 230, which in turn releases the seal cap 1410 and initiates the flow of fluid from the output orifice.

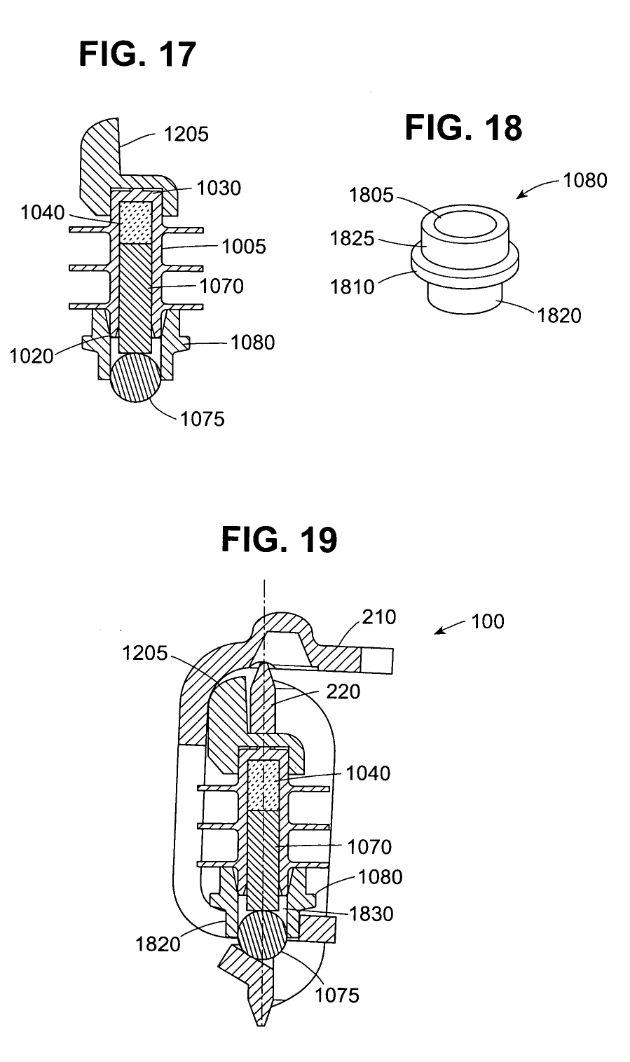

FIG. 17 shows an alternative embodiment in which the displaceable member comprises a solid, cylindrical plunger 1070 and a spherical ball 1075. The plunger 1070 and ball 1075 may be formed of various materials, such as metal (e.g., stainless steel) or ceramic. The plunger 1070 has two flat ends, with one end resting on the fusible material 1040 and the other end extending from the open end 1020 of the sensor 1005. The extended end of the plunger 1070 abuts the ball 1075 inside a lower insulator 1080. In the assembled modular release mechanism 100, the ball 1075 rests in the notch 640 provided in the window 610 of the strut 220 (see FIG. 6). Upon liquefaction of the fusible material 1040, the force applied by the plunger 1070 and ball 1075 to the fusible material 1040 (due to the force on these members applied by the strut 220) causes the fusible material 1040 to flow out of the sensor 1005, thereby allowing the plunger 1070 and ball 1075 to move further into the sensor 1005.

As in the previously described embodiment, the lower insulator 1080 is formed of insulative material, e.g., ceramic, and is positioned around the open end 1020 of the sensor 1005. The lower insulator 1080, as shown in FIG. 18, is generally cylindrical with an opening 1805 through the center for insertion over the open end 1020 of the sensor 1005 and to accommodate the plunger 1070 and ball 1075. The inner radius of the lower insulator 1080 may have a step or transition to accommodate the differing radii of the sensor 1005 and the plunger 1070 and ball 1075 (see FIG. 17). The lower insulator 1080 maintains a slip fit, so as to allow the plunger 1070 and ball 1075 to move freely into the sensor 1005 upon liquefaction of the fusible material 1040. The upper insulator 1205 is as previously described.

As shown in FIG. 19, the outer radius of the lower insulator 1080 may have a step and/or a rim 1810 to facilitate installation into the U-shaped opening 340 at the end 330 of the lever 210. The smaller outer radius portion 1820 of the lower insulator 1080 fits into the U-shaped opening 340 of the lever 210, while the rim 1810 and larger outer radius portion 1825 rest on top of the U-shaped opening 340. Grease or other lubricants may be applied in the area 1830 around the ball 1075 inside the lower insulator 1080 to lubricate the plunger 1070 and ball 1075. This lubrication helps to create a contaminant resistant barrier and exclude corrosive atmospheres from the interior of the sensor, which may in turn help in meeting relevant industry requirements promulgated by Underwriters' Laboratories and Factory Mutual for fire protection sprinklers. In other embodiments, the open end 1020 of the sensor 1005 may extend further into the lower insulator 1080, such that it covers, or nearly covers, the entire plunger 1070.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed is:

1. A release mechanism for a fire protection sprinkler, the sprinkler having a body including an output orifice sealed with a seal cap, the body having two arms extending therefrom that meet at a hub having a preload mechanism, the release mechanism comprising:
a lever having a first end mounted on the preload mechanism;
a strut having a first end mounted on the seal cap and a second end mounted on the first end of the lever; and
a thermally-responsive element mounted on a second end of the lever, opposite the first end, the thermally-responsive element having a displaceable member extending therefrom so as to contact the strut.

2. The release mechanism of claim 1, wherein the release mechanism is formed as a modular assembly such that it is installable into a sprinkler head as a single unit.

3. The release mechanism of claim 1, wherein the first end and the second end of the lever are substantially planar portions formed at approximately right angles to a substantially planar central portion of the lever.

4. The release mechanism of claim 1, wherein the thermally-responsive element is mounted in the second end of the lever by inserting a closed end of the thermally-responsive element, opposite an open end from which the displaceable member extends, into an opening in the second end of the lever.

5. The release mechanism of claim 4, further comprising a first insulator surrounding a portion of the displaceable member and a portion of the open end of the thermally-responsive element, wherein at least a portion of the first insulator is configured to be inserted into the opening in the second end of the lever so as to isolate the thermally-responsive element from the lever.

6. The release mechanism of claim 1, wherein the displaceable member comprises a plunger having a rounded end, the rounded end extending from the thermally-responsive element.

7. The release mechanism of claim 1, wherein the displaceable member comprises a plunger and a ball, the ball extending from the thermally-responsive element.

8. The release mechanism of claim 1, wherein the strut comprises a substantially planar central portion and substantially planar side flanges formed at approximately right angles to the central portion.

9. The release mechanism of claim 1, wherein the strut comprises a window in a central portion of a main surface thereof, and the displaceable member contacts the strut at an inner edge of the window.

10. The release mechanism of claim 9, wherein the thermally-responsive element is positioned within the strut window.

11. The release mechanism of claim 9, wherein the inner edge of the strut window has a notch formed therein, and the displaceable member rests in the notch.

12. The release mechanism of claim 1, wherein the thermally-responsive element comprises:
a sensor having an opening and a hollow interior portion;
fusible material provided in the interior portion; and
the displaceable member inserted in the sensor so as to contact the fusible material and extend from the opening.

13. The release mechanism of claim 12, wherein the sensor comprises a cylindrical metal housing.

14. The release mechanism of claim 13, wherein the cylindrical metal housing comprises circumferential fins.

15. A fire protection sprinkler comprising the release mechanism of claim 1.

16. A release mechanism for a fire protection sprinkler, the sprinkler having a body including an output orifice sealed with a seal cap, the body having two arms extending therefrom that meet at a hub having a preload mechanism, the release mechanism comprising:
a first latching means having a first end mounted on the preload mechanism;
a second latching means having a first end mounted on the seal cap and a second end mounted on the first end of the first latching means; and
a thermally-responsive release means mounted on a second end of the first latching means, opposite the first end of the first latching means, the thermally-responsive release means having a displacement means extending therefrom so as to contact the second latching means.

17. The release mechanism of claim 16, wherein the release mechanism is formed as a modular assembly such that it is installable into a sprinkler head as a single unit.

18. The release mechanism of claim 16, wherein the thermally-responsive release means is mounted in the second end of the first latching means by inserting a closed end of the thermally-responsive release means, opposite an open end from which the displacement means extends, into an opening in the second end of the first latching means.
